(19) United States
(12) Patent Application Publication
(10) Pub. No.: US 2013/0304611 A1
(43) Pub. Date: Nov. 14, 2013

(54) Price Notification and/or Adjustment System in a Web-Based Electronic Commerce Environment

(71) Applicant: Ruchitkumar Shah, Sunnyvale, CA (US)

(72) Inventor: Ruchitkumar Shah, Sunnyvale, CA (US)

(73) Assignee: Wal-Mart Stores, Inc., Bentonville, AR (US)

(21) Appl. No.: 13/468,444

(22) Filed: May 10, 2012

(51) Int. Cl. G06Q 30/00

(52) U.S. Cl. 705/26.61

(57) ABSTRACT

Exemplary embodiments are directed to monitoring items of interest (e.g., goods or services) associated with a web page based on specified parameters. A monitoring request associated with a good or service offered for sale on a web page can be monitored. The monitoring request can include one or more notification parameters associated with the good or service and can be received via a graphical user interface associated with the web page. Update information corresponding to the good or service can be monitored for changes in response to receipt of the monitoring request and a determination can be made as to whether at least one of the notification parameters has been satisfied based on the update information. An electronic notification can be transmitted to a customer in response to the determination that the at least one of the one or more notification parameters has been satisfied.

### BACKGROUND

Many consumers are turning to the Internet to purchase goods and/or services. On-line shopping allows consumers to compare prices to find the best price for the goods and/or services. For example, websites exist, such as www.nextag.com, that allow a consumer to search for a price of a good or service across different on-line merchants so that the consumer can perform a side-by-side comparison between the prices offered by the different merchants. Consumers may consider factors, such as price, a reputation of the merchant, a return policy, guarantees, ease of use of the website, as well as other factors when determining whether to purchase a good or service.

Given the intense competition between on-line merchants for consumers, many on-line merchants offer incentives, such as free shipping, rewards programs, in-store returns, and/or in-store pick-ups. Other approaches to appeal to consumers have been implemented as well. For example, www.priceline.com allows consumers to “name your own price,” for which a consumer submits a bid price for a travel arrangement, such as plane tickets, and if the bid is accepted, the consumer can purchase the plane tickets. However, the consumer typically does not know what airline, flights, and flight times the consumer will receive until after the arrangements have been purchased.

### SUMMARY

Exemplary embodiments of the present disclosure are directed to a system and method in an electronic commerce environment in which a monitoring request from a customer for an item of interest (e.g., a good and/or service) available for purchase from a web page of a merchant's website (e.g., an online retailer, distributor, wholesaler) can be received and the customer can be notified when notification parameters associated with the monitoring request have been satisfied. In exemplary embodiments, the notification parameters can be processed to generate pricing strategies for the good and/or service associated with the notification parameters.

In one embodiment, a method of monitoring parameters associated with an item available for purchase from a web page in an electronic commerce environment is disclosed. The method includes receiving, via a data communications network, an electronic monitoring request associated with a good or service offered on a web page. The monitoring request including one or more notification parameters associated with the good or service received via a graphical user interface associated with the web page. The method also includes programmatically monitoring update information corresponding to the good or service for changes in response to receipt of the monitoring request, determining whether at least one of the notification parameters has been satisfied based on the update information, and transmitting an electronic notification to a customer via the data communications network in response to a determination that the at least one of the one or more notification parameters has been satisfied.

In another embodiment, a non-transitory computer readable medium storing instructions is disclosed. Execution of the instructions by a processing device causes the processing device to implement a process that monitors requests associated with a good or service offered on a web page. The requests include one or more notification parameters associated with the good or service. The process implemented upon execution of the instructions also includes monitoring update information corresponding to the good or service for changes in response to receipt of the monitoring request, determining whether at least one of the notification parameters has been satisfied based on the update information, and transmitting an electronic notification to a customer in response to a determination that the at least one of the one or more notification parameters has been satisfied.

In yet another embodiment, a system for monitoring parameters associated with an item available for purchase from a web page in an electronic commerce environment is disclosed. The system includes computer storage and a processing device. The computer storage stores at least one of notification parameters for a good or service and information corresponding to the good or service. The processing device receives an electronic monitoring requests associated with a good or service offered on a web page that include the notification parameters, programmatically monitors the information corresponding to the good or service for changes in response to receipt of the monitoring requests, programmatically determines whether at least one of the notification parameters has been satisfied based on the update information, and programmatically generates an electronic notification to notify a customer in response to a determination that the at least one of the one or more notification parameters has been satisfied.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary price monitoring and analysis system.

FIG. 2 is a flowchart of an exemplary price notification process implemented by embodiments of the price monitoring and analysis system.

FIG. 3 is a flowchart of an exemplary price modification process implemented by embodiments of the price monitoring and analysis system.

FIG. 4 is an exemplary graphical user interface that can be implemented by embodiments of the price monitoring and analysis system.

FIG. 5 is an exemplary notification that can be generated by embodiments of the price monitoring and analysis system.

FIG. 6 is a block diagram of an exemplary computing device for implementing embodiments of the price monitoring and analysis system.

FIG. 7 is a block diagram of an exemplary computing system for implementing embodiments of the price monitoring and analysis system.

### DESCRIPTION OF EXEMPLARY EMBODIMENTS

Exemplary embodiments of the present disclosure are directed to a system in an electronic commerce environment that can be programmed and/or include executable code configured to receive a monitoring request from a customer for an item of interest (e.g., a good and/or service) available for purchase from a web page of a merchant's website (e.g., an online retailer, distributor, wholesaler), and notify the customer when notification parameters associated with the monitoring request have been satisfied. In exemplary embodiments, the notification parameters can be processed to generate pricing strategies for the good and/or service associated with the notification parameters.

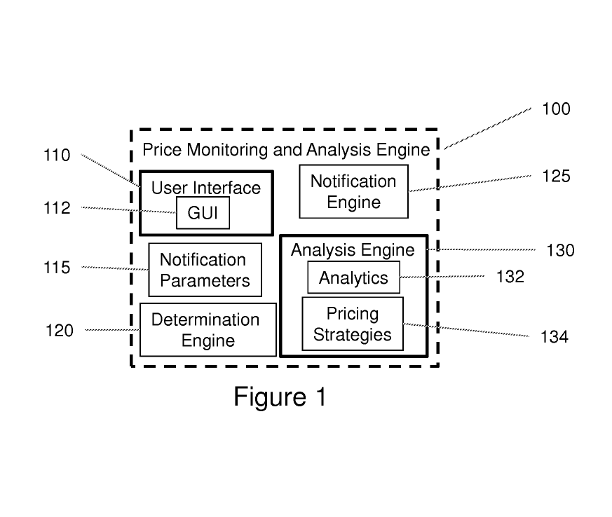

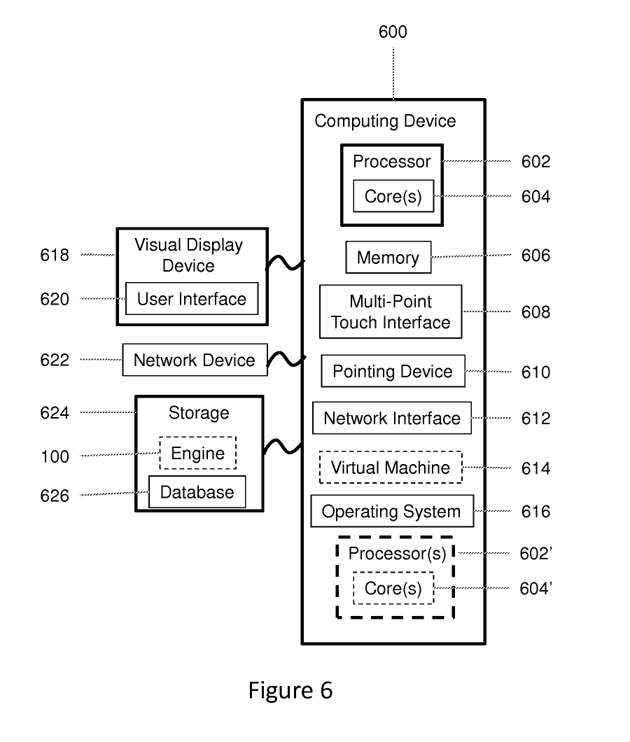

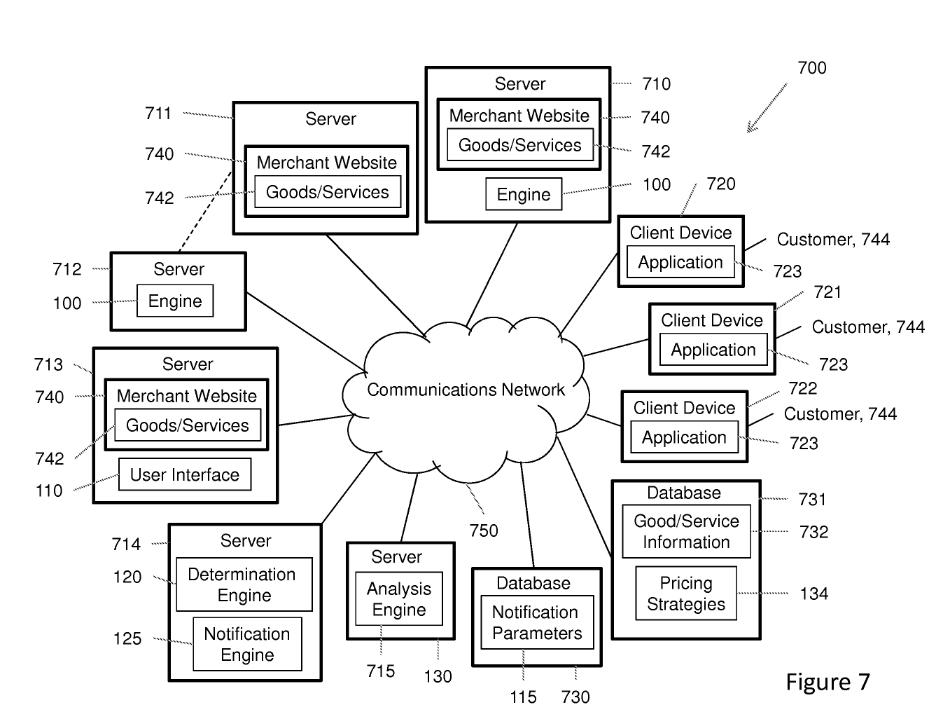

FIG. 1 is a block diagram of an exemplary price monitoring and analysis engine 100 (hereinafter “engine 100”). Exemplary embodiments of the engine 100 can be implemented using hardware, software, and/or a combination thereof. For example, in one exemplary embodiment, a computing device, such as a server, can be configured to implement exemplary embodiments of the engine 100. An exemplary embodiment of a server is shown, for example, in FIGS. 6 and 7. The engine 100 can include a user interface 110, notification parameters 115, a determination engine 120, a notification engine 125, and an analysis engine 130. The engine 100 can be programmed and/or include executable code to implement a notification process to accept price monitoring requests from customers and notify the customers when the notification parameters associated with the requests are satisfied. The engine 100 can be programmed and/or include executable code to implement a price modification process to generate pricing strategies based on the notification parameters.

In exemplary embodiments, the user interface 110 can be programmed and/or include executable code to provide a graphical user interface (GUI) 112 through which a customer can interact with the engine 100. As an example, in some embodiments, the user interface 110 can be associated with one or more web pages of one or more merchant websites such that upon selection of a link on the one or more web pages, the GUI 112 can be displayed to the customer. As another example, in some embodiments, the GUI 112 can be displayed to the customer without selection of a link. The GUI 112 displayed to the customer can include data entry areas to receive information from the customer and/or can include data outputs to display information to the customer. For example, the user interface 110 can be programmed and/or include executable code to receive one or more monitoring requests including the notification parameters 115. In exemplary embodiments, the user interface 110 can programmed and/or include executable code to interface with the determination engine 120, the notification engine 125, and/or the analysis engine 130 to implement a price monitoring process and/or a price modification process using the engine 100.

The notification parameters 115 correspond to parameters specified by the customer and/or engine 100. For example, in exemplary embodiments, the notification parameters 115 can include a price the customer is willing to pay for the item of interest (i.e., a requested price), a time period over which the customer is willing wait for the requested price, customer contact information (e.g., a customer address, phone number, e-mail address), as well as other parameters. In some embodiments, the engine 100 can be programmed and/or include executable code to specify some of the notification parameters and/or to restrict the customer's entries to choices specified by the engine 100. For example, the engine 100 can be programmed and/or include executable code to specify a time period for which the engine 100 monitors the price of the item of interest for the customer, quantity of the item of interest that can be purchased at the requested price, as well as other parameters. Likewise, the engine 100 can be programmed and/or include executable code to restrict the customer's choices by providing a selection of prices, a selection of percent discounts off the present purchase price, and a selection of time periods from which the customer can choose to monitor the item interest. The engine 100 can be programmed and/or include executable code to store the notification parameters 115 for use by the determination engine 120, the notification engine 125, and/or the analysis engine 130.

The determination engine 120 can be programmed and/or include executable code to determine whether monitoring requests specified by the customer are still valid. For example, the determination engine 120 can be programmed and/or include executable code to determine whether the time period specified in the notification parameters of the monitoring request have lapsed or expired. If the notification parameters are still valid, the determination engine 120 can be programmed and/or include executable code to compare the requested price specified in the notification parameters to an updated price of the item of interest to determine whether the updated price is less than or equal to the requested price. The determination engine 120 can be programmed and/or include executable code to receive and/or determine the updated price of the item of interest periodically or otherwise. For example, the determination unit 120 can be programmed and/or include executable code to request a price update from the merchant website, merchant database (e.g., via a database query), and/or from other locations hourly, daily, weekly, monthly, and so on. The determination engine 125 can be programmed and/or include executable code to interface with the notification engine 125 to facilitate transmittal of notifications to the customer based on determinations made of the determination engine 120.

The notification engine 125 can be programmed and/or include executable code to receive determinations made by the determination engine 120 and can generate a notification to be transmitted to a customer. For example, if the determination engine 120 determines that the notification parameters are no longer valid, the notification engine 125 can be programmed and/or include executable code to generate a notification and transmit the notification to notify the customer that the monitoring request has been canceled due to an expiration of the request. Likewise, if the determination engine 120 determines that the notification parameters 115 are valid and satisfied, the notification engine 125 can be programmed and/or include executable code to generate a notification and transmit the notification to notify the customer that the price of the item of interest is less than or equal to the requested price specified in the notification parameters 115.

The notification engine 125 can be programmed and/or include executable code to notify the customer by generating an e-mail notification and transmitting the e-mail notification to the e-mail address specified in the notification parameters, generating a message (e.g., an short message service (SMS) text message or multimedia message service (MMS) message) and transmitting the message to the phone number specified in the notification parameters, generating a recorded message and calling the phone number specified in the notification parameters, and/or using other notifications, such as a printed notification sent via the mail. In some embodiments, the notification sent by the notification engine 125 can include a link, URL address, username, passcode or password, and the like, that the customer can use to purchase the item of interest at the requested price. In some embodiments, the notification can include a time limit for which the offer of the item of interest at the updated price is valid. If the customer fails to purchase the item of interest within the time limit, the offer expires and the updated price is no longer available.

The analysis engine 130 can be programmed and/or include executable code to use analytics 132 based on the notification parameters 115 received from customers. The analytics 132 can be used by the analysis engine 130 to develop pricing strategies 134 for the goods or services associated with the notification parameters 115 and/or to leverage manufacturers of the goods or services to provide more competitive prices. The analytics 132 can be computer-implemented mathematical operations and/or statistical processing that generates the pricing strategies 134. As one example, the analysis engine 130 can be programmed and/or include executable code to implement the analytics to determine new prices for the goods or services to increases sales, while achieving suitable margins, for example by identifying the lowest price at which a desired gross margin, profit margin, net margin, or any other margin or criteria can be achieved. As another example, the analytics 132 can be used to determine an average requested price customers are willing to pay for a good or service and a time period within which the price of the goods should be reduced to the average requested price. As yet another example, the analytics 132 can be used to determine a quantity of monitoring requests have a requested price within a percentage of an offered purchase price. As still another example, the analytics 132 can be used to determine a time period over for which a specified quantity of monitoring requests are valid for the item and to determine a new price of the item based on the quantity of monitoring requests that are valid within the time period.

The analysis engine 130 can be programmed and/or include executable code to use information about the goods or service when generating a pricing strategy based on the analytics 132 and/or can use information corresponding to responses from previous pricing strategies. The analysis engine 130 can be programmed and/or include executable code to generate the pricing strategy based on a unit or wholesale cost of the goods or service to the merchant, a quantity of inventory remaining of the goods or service, whether the good or service is being discontinued, and the like. For example, when a good or service is being discontinued, the analysis engine 130 can be programmed and/or include executable code to generate a new price that is lower than a new price generated if the good or service is not being discontinued.

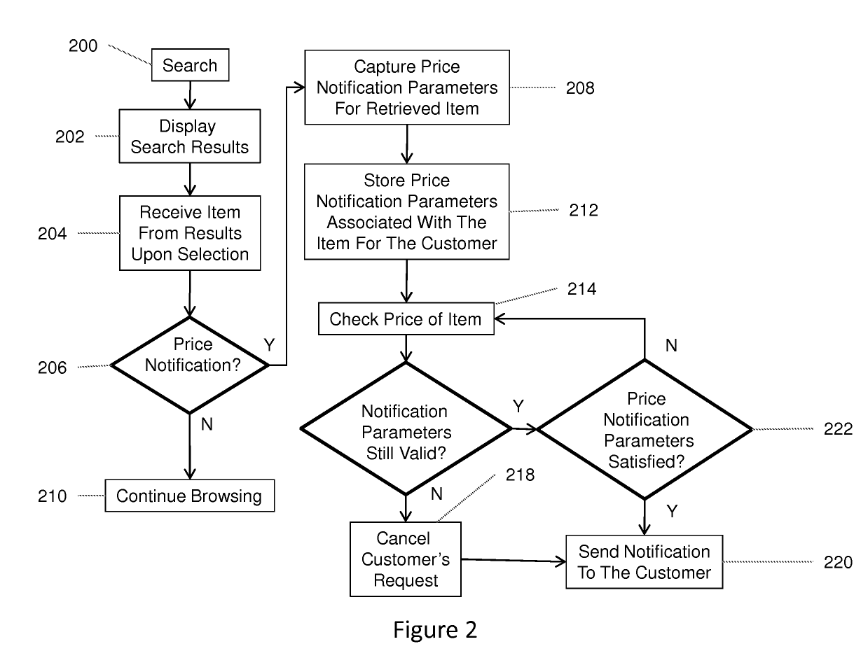

FIG. 2 is a flowchart of an exemplary price notification process that can be implemented by an exemplary embodiment of the engine 100. A customer can visit one or more web pages of a merchant's website to browse for items of interests, such as a good and/or service. In some embodiments, the customer can perform a search, such as a keyword search or can search by following links embedded in the website (step 202). Items of interests resulting from the search can be displayed to the customer (step 204). In some embodiments, items of interest can be displayed to the customer on the web pages without performing a search. The customer can review the item of interest and can select a link associated with the item of interest to initiate one or more actions. For example, selection of a link associated with the item of interest can result in a pop-up window being displayed that includes information concerning the item of interest, the customer's web browser navigating to another webpage to display information concerning the item, an addition of the item of interest to a virtual shopping cart, the GUI of the user interface being displayed, as well as other actions.

If the customer chooses to receive price notifications (step 206), the customer can submit a monitoring request by inputting notification parameters for the item, which can be captured by the GUI of the user interface of the engine 100 (step 208). Otherwise, the customer can continue browsing the web pages (210). If the user chooses to input the notification parameters, the notification parameters associated with the item can be stored for use by the engine 100 to programmatically monitor the price of the item and send notifications to the customer for the item (step 212). The engine 100 can be programmed and/or include executable code to check the price of the item by, for example, querying a database storing price information for the item, accessing a web page of the website and retrieving the price information for the item, and/or can receive updates regarding the price of the item (step 214).

Before proceeding, the engine 100 can be programmed and/or include executable code to determine whether the notification parameters specified for the item are valid. For example, the engine 100 can be programmed and/or include executable code to determine whether the time period associated with the monitoring request has lapsed or expired. If the notification parameters are no longer valid (step 216), the engine 100 can be programmed and/or include executable code to cancel the customer's request (step 218) and send a notification to the customer indicating that the request has been canceled (step 220). If the notification parameters are still valid (step 216), the engine 100 can be programmed and/or include executable code to determine whether the notification parameters are satisfied. If the notification parameters are satisfied (step 222), the engine 100 can be programmed and/or include executable code to transmit a notification the customer indicating that the price of the item is less than or equal to the requested price specified in the notification parameters (step 220). Otherwise, the engine 100 programmatically rechecks the price of the items (step 214) and the validity of the notification parameters (step 216) occasionally and/or periodically. While the present embodiment illustrates a process sequence, those skilled in the art will recognize that other exemplary embodiments can be implement a different sequence. For example, the engine 100 can be programmed and/or include executable code to determine the validity of the notification parameters before checking the price, where the price is checked if the notification parameters are valid.

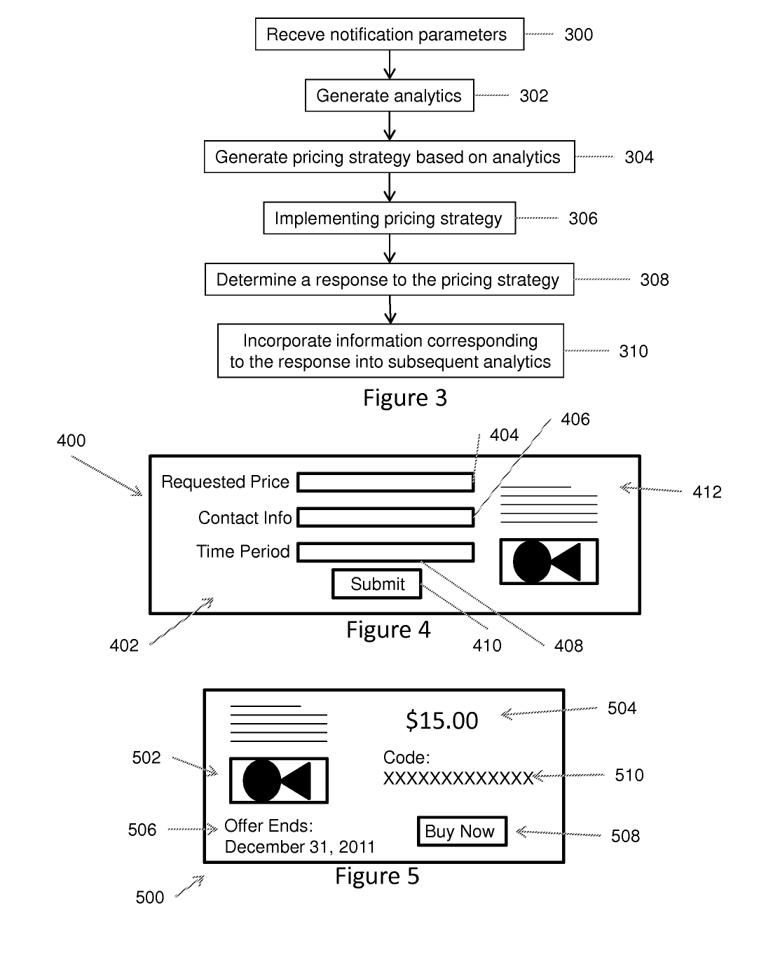

FIG. 3 is a flowchart of an exemplary price modification process that can be implemented using one exemplary embodiment of the engine 100. Stored notification parameters received from customers for a good or service can be retrieved (step 300). The notification parameters can be processed by the engine 100 to programmatically implement analytics (step 302) and a pricing strategy can be generated by the engine 100 using the analytics (step 304). For example, a new price and a time period over which the new price is valid can be generated for the good or service using the analytics. In some embodiments, information about the good or service can be used by the engine 100 in combination with the notification parameters to programmatically implement the analytics such that the pricing strategy can be affected by the information about the good or service. The website on which the good or service is being offered for sale can be programmatically updated by the engine 100 to automatically implement the pricing strategy, for example, by changing the price of the good or service using the new price and time period generated (step 306) and the customers that submitted notification parameters satisfying the new price and time period can be notified. While the present embodiment automatically updates the website, those skilled in the art will recognize that a user may be prompted to review, approve, and/or implement the price change.

In exemplary embodiments, the price modification process can determine a response to the pricing strategy (e.g., a number of customers that purchased the good or service in response to receiving a notification) (step 308) and can incorporate information corresponding to the response into a determination of the analytics for subsequent pricing strategies (step 310).

FIG. 4 is an exemplary GUI 400 that can be provided by an exemplary embodiment of the user interface 110. The GUI 400 can include data entry fields 402 to receive inputs from the user. For example, a data entry field 404 can facilitate entry of a requested price for an item of interest, data entry fields 406 can request customer contact information, and data entry fields 408 can request a time period over which the customer chooses to receive notifications about the price of the item of interest. Once the user has entered the requested data in the data entry fields 402, the user can click on a submit button 410 to initiate the price notification process. In exemplary embodiments, the GUI 400 can also include information 412 corresponding to the item of interest to be monitored (e.g., text and/or a graphic).

FIG. 5 is an exemplary notification 500 that can be generated and transmitted to a customer by an exemplary embodiment of the notification engine 125. The notification 500 can include a description 502 of the good or service (e.g., text and/or a graphic), a price 504 of the good or service, and a time period 506 over which the price of the good or service will remain valid. In some embodiments, the notification 500 can also include a link 508 to connect the customer to the website to facilitate a purchase of the good or service and a data code 510 to be entered by the customer when purchasing the good or service to ensure the customer receives the good or service for the price 504 set forth in the notification 500.

FIG. 6 is a block diagram of an exemplary computing device 600 that may be used in to implement exemplary embodiments of the engine 100. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 606 included in the computing device 600 may store computer-readable and computer-executable instructions or software for implementing exemplary embodiments of the engine 100. The computing device 600 also includes configurable and/or programmable processor 602 and associated core 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ may each be a single core processor or multiple core (604 and 604′) processor.

Virtualization may be employed in the computing device 600 so that infrastructure and resources in the computing device may be shared dynamically. A virtual machine 614 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 618, such as a computer monitor, which may display one or more user interfaces 620 that may be provided in accordance with exemplary embodiments. The computing device 600 may include other I/O devices for receiving input from a user, for example, a keyboard or any suitable multi-point touch interface 608, a pointing device 610 (e.g., a mouse). The keyboard 1008 and the pointing device 610 may be coupled to the visual display device 618. The computing device 600 may include other suitable conventional I/O peripherals.

The computing device 600 may also include one or more storage devices 624, such as a hard-drive, CD-ROM, or other computer readable media, for storing data and computer-readable instructions and/or software that implement exemplary embodiments of the engine 100 described herein. Exemplary storage device 624 may also store one or more databases for storing any suitable information required to implement exemplary embodiments. For example, exemplary storage device 624 can store one or more databases 626 for storing information, such as notification parameters, item information, customer information, vendor (or manufacturer) information, and/or any other information to be used by embodiments of the engine 100. The databases may be updated by manually or automatically at any suitable time to add, delete, and/or update one or more items in the databases.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 may include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 600 may run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 616 may be run in native mode or emulated mode. In an exemplary embodiment, the operating system 616 may be run on one or more cloud machine instances.

FIG. 7 is a block diagram of an exemplary computing system 700 configured to implement one or more embodiments of the engine 100. The computing system 700 includes servers 710-715 operatively coupled to clients 720-722, via a communication network 750, which can be any network over which information can be transmitted between devices communicatively coupled to the network. For example, the communication network 750 can be the Internet, Intranet, virtual private network (VPN), wide area network (WAN), local area network (LAN), and the like. The computing system 700 can include repositories or database devices 730, 731, which can be operatively coupled to the servers 710-715, as well as to clients 720-722, via the communications network 750. The servers 710-715, clients 720-322, and database devices 730, 731 can be implemented as computing devices. Those skilled in the art will recognize that the database devices 730, 731 can be incorporated into one or more of the servers 710-715 such that one or more of the servers can include databases.

In some embodiments, embodiments of the engine 100 can be implemented by a single device, such as server 710 and/or server 712. In some embodiments, the engine 100 can be distributed among different devices (e.g., servers, clients, databases) in the communication network 750 such that one or more components of the engine 100, or portions thereof, can be implemented by different devices in the communication network 750. For example, in illustrative embodiments, the user interface 110 can be implemented by a server 713, the notification parameters 115 can be stored in the database 730, good/service information 732 and/or pricing strategies 134 can be stored by database 731, the determination engine 120 and the notification engine 125 can be implemented by the server 714, and the analysis engine 130 can be implemented by the server 715.

In an exemplary embodiment, servers 710, 711, and 713 can be web servers configured to host web pages, such as web pages of merchant websites 740, which are configured to facilitate electronic commerce transactions for goods and/or services 742. Client 720-722 can represent computing devices having a client-side application 723, such as a web browser, mobile phone application, or any other suitable client-side application that permits the clients 720-722 to interact with one or more of the servers 710-715.

Embodiments of the engine 100 can be associated with one or more websites 740 from which goods and/or services 742 can be purchased by customers 744 via clients 720-722. For example, the engine 100, or a portion thereof, and one or more of the websites 135 can be implemented together on one or more of the servers 710-715 and/or the engine 100 can be implemented on a separate server that is in communication with servers that implement the one or more websites 135.

In an exemplary operation, the customers can visit one or more of the websites 740 hosted by the servers 710, 711, and 713 using the client-side application 742 via the communications network 750 and the customers can browse the websites 740 for the goods/service 742 being sold on the websites 740. When a customer identifies one or more goods and/or services that the customer is interested in purchasing (e.g., items of interest), a monitoring request can be initiated and the engine 100 can display the user interface 110. The customer can use the engine 100 to monitor the price and notify the customer if the price of an items of interest satisfies one or more notification parameters 115 specified by the user.

For embodiments in which the engine 100 is implemented on the server 710, the engine 100 can be integrated with the website 740 so that the user interface 110 of the engine 100 can be included in the website. For embodiments in which the engine 100 is implemented on a separate server than the website 140 (e.g., servers 711, 712), the server 711 can communicate with the server 712 to implement embodiments of the engine 100. For example, the servers 711 and 712 can communicate over the communications network 750 and/or can communicate via another connection, such as a direct connection or via another communication network, which is illustrated as a dashed line between the servers 711 and 712 in FIG. 7. For embodiments in which the engine 100 is distributed on different servers (e.g., 713-715), the user interface 110 of the engine 100 can be integrated with the website 740 hosted by server 713, which can be in communication with the servers 714 and 715 to implement embodiments of the engine 100. Furthermore, embodiments of the engine 100 can be in communication with the databases 730 and 731 to store and/or retrieve information and/or parameters to facilitate embodiments of the price monitoring process and/or the price modification process implemented by embodiments of the engine 100.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method of monitoring parameters associated with an item available for purchase from a web page in an electronic commerce environment, the method comprising:
receiving, via a data communications network, an electronic monitoring request associated with the item offered on a web page, the monitoring request including one or more notification parameters associated with the item received via a graphical user interface associated with the web page;
programmatically monitoring update information corresponding to the item for changes in response to receipt of the monitoring request;
programmatically determining whether at least one of the notification parameters has been satisfied based on the update information; and
transmitting an electronic notification to a customer via the data communications network in response to a determination that the at least one of the one or more notification parameters has been satisfied.

2. The method of claim 1, wherein the one or more notification parameters includes a requested price for the item.

3. The method of claim 1, wherein the one or more notification parameters includes a time period for which the notification parameters are valid.

4. The method of claim 1, wherein programmatically determining whether at least one of the notification parameters has been satisfied comprises comparing the notification parameter to the update information.

5. The method of claim 1, wherein programmatically monitoring update information comprises electronically querying a database in which the update information is stored and transmitting an electronic notification comprises at least one of sending an e-mail to the customer, sending a text message the customer, initiating an automated telephone call with the customer including a recorded message.

6. The method of claim 1, further comprising programmatically generating a pricing strategy based on the notification parameters.

7. The method of claim 6, further comprising programmatically generating the pricing strategy based on information corresponding to the item.

8. The method of claim 6, wherein programmatically generating a pricing strategy comprises programmatically determining at least one of an average requested price specified in a plurality of monitoring requests received for the item, a quantity of monitoring requests having a requested price within a predetermined percentage of an offered purchase price, and a lowest requested price that satisfies a profit margin ratio.

9. The method of claim 8, wherein programmatically generating a pricing strategy comprises programmatically determining an overlapping time period over which a predetermined percentage of monitoring requests are valid.

10. The method of claim 6, further comprising programmatically generating the pricing strategy based on analytics.

11. The method of claim 6, further comprising:
programmatically implementing the pricing strategy;
programmatically determining a response to the pricing strategy; and
programmatically incorporating information corresponding to the response into a determination of analytics for subsequent pricing strategies.

12. The method of claim 6, wherein programmatically generating a pricing strategy comprises programmatically adjusting a purchase price of the item of interest to an average price.

13. The method of claim 6, wherein programmatically generating a pricing strategy comprises programmatically computing a lower purchase price based on analytics, the lower purchase price being valid for a predetermined offer time period.

14. A non-transitory computer readable medium storing executable instructions, wherein execution of the instructions by a programmable processing device causes the processing device to implement a process comprising:
receiving, via a data communications network, an electronic monitoring request associated with an item of interest offered on a web page, the monitoring request including one or more notification parameters associated with the item of interest received via a graphical user interface associated with the web page;
programmatically monitoring update information corresponding to the item of interest for changes in response to receipt of the monitoring request;
programmatically determining whether at least one of the notification parameters has been satisfied based on the update information; and
transmitting an electronic notification to a customer via the communications network in response to a determination that the at least one of the one or more notification parameters has been satisfied.

15. The medium of claim 14, wherein the process implemented upon execution of the instructions further comprises programmatically generating a pricing strategy based on the notification parameters.

16. The medium of claim 15, wherein the process implemented upon execution of the instructions further comprises:
programmatically implementing the pricing strategy;
programmatically determining a response to the pricing strategy; and
programmatically incorporating information corresponding to the response into a determination of the analytics for subsequent pricing strategies.

17. A system for monitoring parameters associated with an item available for purchase from a web page in an electronic commerce environment, the system comprising:
a network interface communicatively coupled to a communications network;
a configurable processing device communicatively coupled to the network interface, processing device configured to:
receive an electronic monitoring request associated with an item of interest offered on a web page via the network interface, the monitoring request including the notification parameters;
programmatically monitor the information corresponding to the item of interest for changes in response to receipt of the monitoring request;
programmatically determine whether at least one of the notification parameters has been satisfied based on the update information; and
programmatically generate an electronic notification to notify a customer in response to a determination that the at least one of the one or more notification parameters has been satisfied.

18. The system of claim 17, wherein the processing device is further configured to:
generate a pricing strategy based on the notification parameters.

19. The system of claim 18, wherein the processing device is further configured to:
implement the pricing strategy;
determine a response to the pricing strategy; and
incorporate information corresponding to the response into a determination of analytics for subsequent pricing strategies.

20. The system of claim 18, wherein the processing device is further configured to generate a pricing strategy by computing a lower purchase price based on analytics, the lower purchase price being valid for a predetermined offer time period.
